(19) United States
(12) Patent Application Publication
(10) Pub. No.: US 2020/0295964 A1
(43) Pub. Date: Sep. 17, 2020

(54) GAS FEE NOTIFICATION METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/355,698

(22) Filed: Mar. 15, 2019

(51) Int. Cl. H04L 12/28; G06Q 50/06; G01D 4/00; G01D 4/18

(52) U.S. Cl. CPC H04L 12/2827; G01D 4/18; G01D 4/006; G06Q 50/06

(57) ABSTRACT

The present invention relates to the field of Internet of Things (IoT), and provides a gas fee notification method based on a compound IoT and an IoT system. The IoT system includes a user platform, a plurality of service sub-platforms, a management platform, a sensor network platform and a plurality of object sub-platforms; and each of the object sub-platforms includes a gas meter. The gas fee notification method based on the compound IoT and the IoT system provided by the present invention can remind a user when a pricing tier for gas consumption of the user changes, and help the user plan the gas usage, thereby advocating the spirit of energy conservation and environmental protection.

### TECHNICAL FIELD

The present invention relates to the field of Internet of Things (IoT), and in particular to a gas fee notification method based on a compound IoT and an IoT system.

### BACKGROUND

In order to advocate the social spirit of energy conservation and environmental protection, a tiered pricing policy is pushed forward by the government for gas charging to encourage a citizen and an enterprise to save gas. However, in the process of a gas user to use the gas, the user cannot get to know directly in time when a gas consumption amount enters a next pricing tier, and knows which tier the gas consumption is located only when settling a gas fee every month or every quarter, which does not have obvious effect to advocate the gas saving.

### SUMMARY OF THE INVENTION

In view of this, an objective of the present invention is to provide a gas fee notification method based on a compound IoT and an IoT system to notify a user in time when a charging standard for a gas consumption amount of the user changes.

To this end, the technical solutions adopted by the present invention are as follows:

According to a first aspect, the present invention provides a gas fee notification method based on a compound IoT; the method is applied to an IoT system; the IoT system comprises a user platform, a plurality of service sub-platforms, a management platform, a sensor network platform and a plurality of object sub-platforms; each of the object sub-platforms comprises a gas meter; and the method comprises:

capturing, by the management platform, a latest tiered pricing policy from the plurality of service sub-platforms at a preset time interval;

obtaining, by the management platform, a pricing rule according to the captured tiered pricing policy;

sending, by the management platform, the pricing rule to each of the gas meters via the sensor network platform;

judging, by each of the gas meters, whether or not a tier where a gas consumption amount of a user is located changes according to the read gas data and received pricing rule;

when a tier where a gas consumption amount of a user is located changes, sending, by a gas meter, a change signal to the management platform via the sensor network platform, where the change signal includes gas data read by the gas meter; and

in response to the change signal, sending, by the management platform, tiered pricing change information to the user platform via at least one of the plurality of service sub-platforms.

Further, the method includes:

sending, by each of the object sub-platforms, gas data of a gas meter to the management platform via the sensor network platform according to predetermined time;

collating, by the management platform, gas data of a plurality of gas meters to obtain a gas consumption chart;

respectively labeling, by the management platform, gas data of each gas meter in the gas consumption chart to generate a customized gas consumption chart of each gas meter; and

sending, by the management platform, each of the customized gas consumption charts to the user platform via at least one of the plurality of service sub-platforms.

Further, the gas consumption chart includes a gas data average value, a gas data maximum value and a gas data minimum value for the plurality of data meters in a unit time.

Further, the plurality of service sub-platforms include at least one of a gas company service platform, a government service platform or a social operator service platform.

Further, each of the gas meters corresponds to an identifier, and the change signal includes an identifier of the gas meter.

According to a second aspect, the present invention further provides an IoT system; the IoT system includes a user platform, a plurality of service sub-platforms, a management platform, a sensor network platform and a plurality of object sub-platforms; the plurality of object sub-platforms are communicatively connected with the management platform via the sensor network platform; the management platform is communicatively connected with the plurality of service sub-platforms; the plurality of service sub-platforms are communicatively connected with the user platform; and each of the object sub-platforms includes a gas meter;

the management platform is configured to capture a latest tiered pricing policy from the plurality of service sub-platforms at a preset time interval, obtain a pricing rule according to the captured tiered pricing policy, and send the pricing rule to each of the gas meters via the sensor network platform;

each of the gas meters is configured to judge whether or not a tier where a gas consumption amount of a user is located changes according to the read gas data and received pricing rule;

when a tier where a gas consumption amount of a user is located changes, a gas meter sends a change signal to the management platform via the sensor network platform, where the change signal includes gas data read by the gas meter; and

the management platform sends, in response to the change signal, tiered pricing change information to the user platform via at least one of the plurality of service sub-platforms.

Further, each of the object sub-platforms is further configured to send gas data of a gas meter to the management platform via the sensor network platform according to predetermined time; and

the management platform is configured to collate gas data of a plurality of gas meters to obtain a gas consumption chart, respectively label gas data of each gas meter in the gas consumption chart to generate a customized gas consumption chart of each gas meter, and send each of the customized gas consumption charts to the user platform via at least one of the plurality of service sub-platforms.

Further, the gas consumption chart includes a gas data average value, a gas data maximum value and a gas data minimum value for the plurality of data meters in a unit time.

Further, the plurality of service sub-platforms include at least one of a gas company service platform, a government service platform or a social operator service platform.

Further, each of the gas meters corresponds to an identifier, and the change signal includes an identifier of the gas meter.

The present invention provides a gas fee notification method based on a compound IoT and an IoT system. The IoT system includes a user platform, a plurality of service sub-platforms, a management platform, a sensor network platform and a plurality of object sub-platforms; and each of the object sub-platforms includes a gas meter. The method includes: capturing, by the management platform, a latest tiered pricing policy from the plurality of service sub-platforms at a preset time interval; obtaining, by the management platform, a pricing rule according to the captured tiered pricing policy; sending, by the management platform, the pricing rule to each of the gas meters via the sensor network platform; judging, by each of the gas meters, whether or not a tier where a gas consumption amount of a user is located changes according to the read gas data and received pricing rule; when a tier where a gas consumption amount of a user is located changes, sending, by a gas meter, a change signal to the management platform via the sensor network platform, where the change signal includes gas data read by the gas meter; and in response to the change signal, sending, by the management platform, tiered pricing change information to the user platform via at least one of the plurality of service sub-platforms. By obtaining the latest tiered pricing policy and in combination with a gas consumption amount of a user to judge whether or not a pricing tier for the gas consumption amount of the user at present changes, and to remind the user when the pricing tier changes, the present invention helps the user know a gas consumption condition in time and plan the gas usage, thereby advocating the spirit of energy conservation and environmental protection.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates a compositional schematic diagram of an IoT system provided by an embodiment of the present invention;

FIG. 2 illustrates a flowchart of a gas fee notification method based on a compound IoT provided by an embodiment of the present invention;

FIG. 3 illustrates a diagram of an application scenario of a gas fee notification method based on a compound IoT provided by an embodiment of the present invention; and

FIG. 4 illustrates a diagram of an application scenario of a gas fee notification method based on a compound IoT provided by an embodiment of the present invention.

Numerals in the drawings: 100-IoT system; 10-user platform; 20-service sub-platform; 30-management platform; 40-sensor network platform; 50-object sub-platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

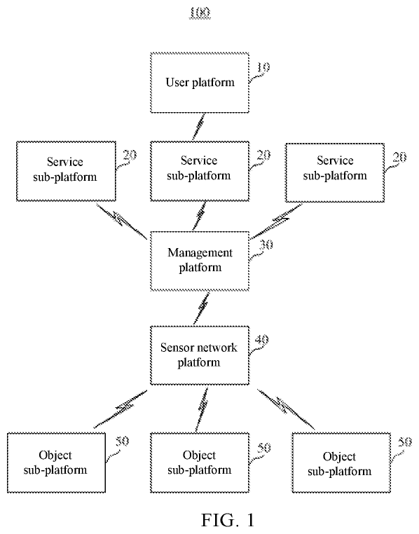

Referring to FIG. 1, a gas fee notification method based on a compound IoT provided by an embodiment of the present invention is applied to an IoT system 100. The IoT system 100 includes a user platform 10, a plurality of service sub-platforms 20, a management platform 30, a sensor network platform 40 and a plurality of object sub-platforms 50. Herein, the plurality of object sub-platforms 50 may be communicatively connected with the management platform 30 via the sensor network platform 40 to send data of the object sub-platforms 50 to the management platform 30, or receive a signal sent by the management platform 30. Each of the object sub-platforms 50 includes a gas meter. A plurality of gas meters may be gas meters in a residence community or an apartment building. The management platform 30 is communicatively connected with the plurality of service sub-platforms 20. In this embodiment, the service sub-platforms 20 include at least one of a gas company service platform, a government service platform or a social operator service platform. The service sub-platforms 20 are communicatively connected with the user platform 10, and are configured to push information sent by the management platform 30 to the user platform 10. In this embodiment, the user platform 10 may be a server of a property management center of the residence community or a server of a property management center of the apartment building. The management platform 30 and the service sub-platforms 20 each may be a server.

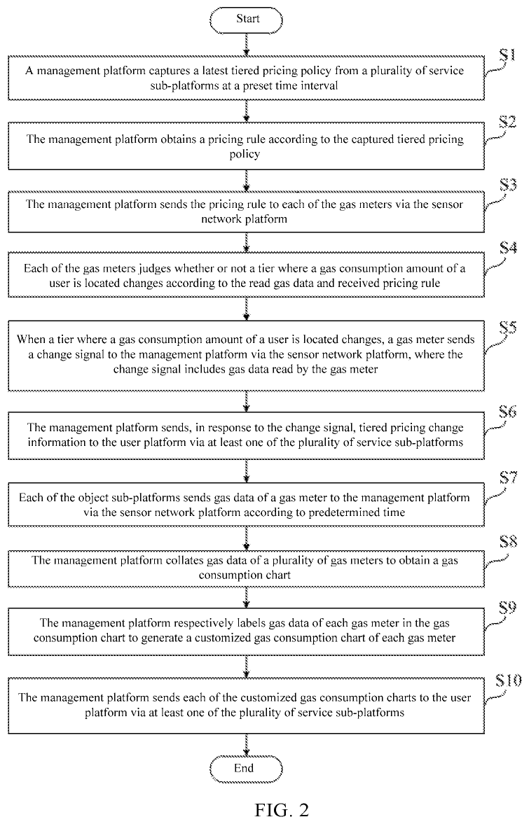

Referring to FIG. 2, the gas fee notification method based on the compound IoT includes the following steps:

Step S1, a management platform captures a latest tiered pricing policy from a plurality of service sub-platforms at a preset time interval.

As a tiered pricing policy may change, in this embodiment of the present invention, the management platform 30 captures the latest tiered pricing policy from the service sub-platforms 20 at intervals, such as from an official website of a government service platform, or from a portal website of a gas company service platform, or from a public webpage of a social operator service platform. The capture frequency can be set based on an actual situation, e.g., the management platform 30 may be set to capture the latest tiered pricing policy from the service sub-platforms 20 every other day.

Step S2, the management platform obtains a pricing rule according to the captured tiered pricing policy.

The tiered pricing policy obtained by the management platform 30 is usually described in words and cannot be recognized by a computer. Therefore, the management platform 30 needs to “translate” the tiered pricing policy into a computer-identifiable pricing rule, such as a formula.

Step S3, the management platform sends the pricing rule to each of the gas meters via the sensor network platform.

In this embodiment, the sensor network platform 40 may be a gateway, and a plurality of gas meters communicate with the management platform 30 via one gateway to complete data interaction.

Step S4, each of the gas meters judges whether or not a tier where a gas consumption amount of a user is located changes according to the read gas data and received pricing rule.

Each of the gas meters reads gas data used by a user in real time, and judges, upon the reception of the pricing rule sent by the management platform 30, according to the current gas data, whether or not a tier where a gas consumption amount used by the user at present is located changes compared with a previous judgment result. For example, when the previous gas data of a gas meter is 100 m³ and the pricing tier is a first tier; however, in this time of judgment, the gas data is 150 m³ and the pricing tier changes to a second tier. It may be determined by the gas meter that the tier where the gas consumption amount of the user is located has changed.

Step S5, when a tier where a gas consumption amount of a user is located changes, a gas meter sends a change signal to the management platform via the sensor network platform, where the change signal includes gas data read by the gas meter.

Upon the judgment of that a gas consumption amount of a user changes, a gas meter needs to instruct the management platform 30 to facilitate the processing of the management platform 30.

Step S6, the management platform sends, in response to the change signal, tiered pricing change information to the user platform via at least one of the plurality of service sub-platforms.

After the management platform 30 knows that a tier for a gas consumption amount of a user changes, it may push tiered pricing change information to the user platform 10 via the gas company service platform or the government service platform.

The user platform 10 is a user terminal. In this embodiment, the user terminal may be a general electronic device such as a Personal Computer (PC), a smartphone, a tablet computer, a Personal Digital Assistant (PDA), a Mobile Internet Device (MID), and the like.

It is easily understood that the owner of the plurality of gas meters is a same user. Each of the gas meters is provided with a unique identifier, such as a number, an ID and a two-dimensional code. A user terminal of a user is associated with a gas meter and a corresponding table therebetween may be stored in the management platform 30, so that an identifier of the gas meter is associated with identifiable information, such as a telephone number and a software account number, of the user terminal. It is easily understood that after the management platform 30 sends the tiered pricing change information to the user platform 10, the user may know that the pricing tier for the gas consumption amount at present changes and then the user adjusts a gas consumption strategy in time to save the gas.

In this embodiment, with adoption of the technical solutions, when the pricing tier for the gas consumption amount of the user changes, the pricing tier change information is sent to the user platform 10. It is to be noted that, in other embodiments, when the gas consumption amount of the user is close to a gas consumption amount at which a pricing tier changes, prompt information may be sent to the user platform 10 to prompt that the pricing tier is to change, which is not limited by the present invention.

Through the above steps, the gas fee notification method based on the compound IoT provided by this embodiment of the present invention may remind the user in time when the pricing tier for the gas consumption amount of the user changes, and help the user know a gas consumption condition in time and plan the gas usage, thereby advocating the social spirit of energy conservation and environmental protection.

In addition, the gas fee notification method based on the compound IoT provided by this embodiment of the present invention may further push a gas consumption condition of a residence community or an area where the user is located to the user, which may be implemented via the following steps.

Step S7, each of the object sub-platforms sends gas data of a gas meter to the management platform via the sensor network platform according to predetermined time.

The predetermined time described herein may be set freely and may be, for example, set at 7:00 pm every day.

Step S8, the management platform collates gas data of a plurality of gas meters to obtain a gas consumption chart.

The content of the gas consumption chart may be collated based on an actual demand. For example, as shown in FIG. 3, the gas consumption chart may include a gas data average value, a gas data maximum value and a gas data minimum value for the plurality of data meters in a unit time.

Step S9, the management platform respectively labels gas data of each gas meter in the gas consumption chart to generate a customized gas consumption chart of each gas meter.

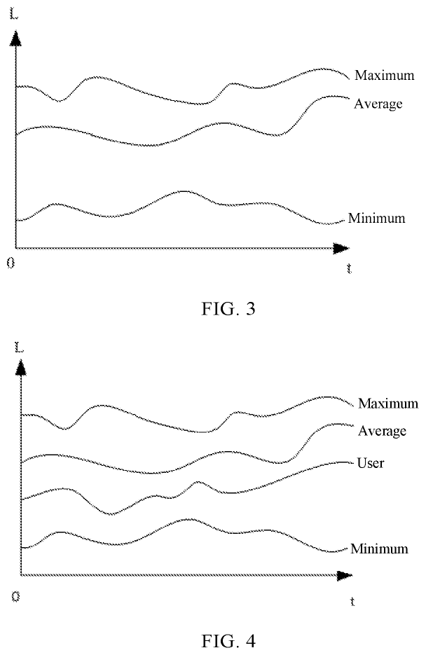

After the gas consumption chart is generated, it is possible that the gas consumption chart is not intuitive to the user and thus a gas consumption data situation of the user may be labeled in the gas consumption chart. It is easily understood that only gas data of a corresponding gas meter is labeled on each customized gas consumption chart, as shown in FIG. 4.

Step S10, the management platform sends each of the customized gas consumption charts to the user platform via at least one of the plurality of service sub-platforms.

By sending each of the customized gas consumption charts to a user terminal of a user, the user may conveniently know a gas consumption level in a residence community or an area where he/she is located and know a position where the own gas consumption amount is located in the residence community or the area, thereby adjusting a gas consumption strategy and promoting the user to develop a gas saving habit.

In conclusion, the embodiment of the present invention provides a gas fee notification method based on a compound IoT and an IoT system. The IoT system includes a user platform, a plurality of service sub-platforms, a management platform, a sensor network platform and a plurality of object sub-platforms; each of the object sub-platforms includes a gas meter; and each of the gas meters is associated with a user terminal. The method includes: a management platform captures a latest tiered pricing policy from a plurality of service sub-platforms at a preset time interval; the management platform obtains a pricing rule according to the captured tiered pricing policy; the management platform sends the pricing rule to each of the gas meters via the sensor network platform; each of the gas meters judges whether or not a tier where a gas consumption amount of a user is located changes according to the read gas data and received pricing rule; when a tier where a gas consumption amount of a user is located changes, a gas meter sends a change signal to the management platform via the sensor network platform, where the change signal includes gas data read by the gas meter; and the management platform sends, in response to the change signal, tiered pricing change information to the user platform via at least one of the plurality of service sub-platforms. By obtaining the latest tiered pricing policy and in combination with a gas consumption amount of a user to judge whether or not a pricing tier for the gas consumption amount of the user at present changes, and to remind the user when the pricing tier changes, the present invention helps the user know a gas consumption condition in time.

In addition, in this embodiment of the present invention, a customized gas consumption chart may further be pushed to the user, so that the user conveniently knows a position where the gas consumption amount is located in a residence community or an area, thereby planning the gas usage, adjusting a gas consumption strategy, promoting the user to develop a gas saving habit and advocating the social spirit of energy conservation and environmental protection.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

What is claimed is:

1. A gas fee notification method based on a compound Internet of Things (IoT), wherein the method is applied to an IoT system; the IoT system comprises a user platform, a plurality of service sub-platforms, a management platform, a sensor network platform and a plurality of object sub-platforms; each of the object sub-platforms comprises a gas meter; and the method comprises:
capturing, by the management platform, a latest tiered pricing policy from the plurality of service sub-platforms at a preset time interval;
obtaining, by the management platform, a pricing rule according to the captured tiered pricing policy;
sending, by the management platform, the pricing rule to each of the gas meters via the sensor network platform;
judging, by each of the gas meters, whether or not a tier where a gas consumption amount of a user is located changes according to the read gas data and received pricing rule;
when a tier where a gas consumption amount of a user is located changes, sending, by a gas meter, a change signal to the management platform via the sensor network platform, wherein the change signal comprises gas data read by the gas meter; and
in response to the change signal, sending, by the management platform, tiered pricing change information to the user platform via at least one of the plurality of service sub-platforms.

2. The gas fee notification method based on the compound IoT according to claim 1, wherein the method further comprises:
sending, by each of the object sub-platforms, gas data of a gas meter to the management platform via the sensor network platform according to predetermined time;
collating, by the management platform, gas data of a plurality of gas meters to obtain a gas consumption chart;
respectively labeling, by the management platform, gas data of each gas meter in the gas consumption chart to generate a customized gas consumption chart of each gas meter; and
sending, by the management platform, each of the customized gas consumption charts to the user platform via at least one of the plurality of service sub-platforms.

3. The gas fee notification method based on the compound IoT according to claim 2, wherein the gas consumption chart comprises a gas data average value, a gas data maximum value and a gas data minimum value for the plurality of data meters in a unit time.

4. The gas fee notification method based on the compound IoT according to claim 1, wherein the plurality of service sub-platforms comprise at least one of a gas company service platform, a government service platform or a social operator service platform.

5. The gas fee notification method based on the compound IoT according to claim 1, wherein each of the gas meters corresponds to an identifier; and the change signal comprises an identifier of the gas meter.

6. An Internet of Things (IoT) system, wherein the IoT system comprises a user platform, a plurality of service sub-platforms, a management platform, a sensor network platform and a plurality of object sub-platforms; the plurality of object sub-platforms are communicatively connected with the management platform via the sensor network platform; the management platform is communicatively connected with the plurality of service sub-platforms; the plurality of service sub-platforms are communicatively connected with the user platform; and each of the object sub-platforms comprises a gas meter;
the management platform is configured to capture a latest tiered pricing policy from the plurality of service sub-platforms at a preset time interval, obtain a pricing rule according to the captured tiered pricing policy, and send the pricing rule to each of the gas meters via the sensor network platform;
each of the gas meters is configured to judge whether or not a tier where a gas consumption amount of a user is located changes according to the read gas data and received pricing rule;
when a tier where a gas consumption amount of a user is located changes, a gas meter sends a change signal to the management platform via the sensor network platform, wherein the change signal comprises gas data read by the gas meter; and
the management platform sends, in response to the change signal, tiered pricing change information to the user platform via at least one of the plurality of service sub-platforms.

7. The IoT system according to claim 6, wherein each of the object sub-platforms is further configured to send gas data of a gas meter to the management platform via the sensor network platform according to predetermined time; and
the management platform is configured to collate gas data of a plurality of gas meters to obtain a gas consumption chart, respectively label gas data of each gas meter in the gas consumption chart to generate a customized gas consumption chart of each gas meter, and send each of the customized gas consumption charts to the user platform via at least one of the plurality of service sub-platforms.

8. The IoT system according to claim 7, wherein the gas consumption chart comprises a gas data average value, a gas data maximum value and a gas data minimum value for the plurality of data meters in a unit time.

9. The IoT system according to claim 6, wherein the plurality of service sub-platforms comprise at least one of a gas company service platform, a government service platform or a social operator service platform.

10. The IoT system according to claim 6, wherein each of the gas meters corresponds to an identifier; and the change signal comprises an identifier of the gas meter.
